(19) United States
(12) Patent Application Publication
(10) Pub. No.: US 2010/0071362 A1
(43) Pub. Date: Mar. 25, 2010

(54) PRESSURE SYSTEM HAVING AT LEAST TWO PRESSURE CIRCUITS

(76) Inventors: Norbert Alaze, Markgroeningen (DE); Marcus Egle, Freiberg (DE); Thomas Michl, Stuttgart (DE); Horst Beling, Heilbronn (DE); Klaus Habr, Stuttgart (DE); Heiko Druckenmueller, Steinheim A.D. Murr (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 11/722,223

(22) PCT Filed: Oct. 31, 2005
(86) PCT No.: PCT/EP2005/055666

§ 371 Date: Dec. 7, 2009

(30) Foreign Application Priority Data
Dec. 22, 2004 (DE) 10 2004 061 811.9

(51) Int. Cl. B60T 13/10; F04B 23/06

(52) U.S. Cl. 60/581; 137/565.33

(57) ABSTRACT

A pressure system having at least two pressure circuits each including a respective positive-displacement element and each compression side of the positive-displacement elements being in operative communication via a compensation device in such a way that a pressure increase in the first pressure circuit leads to a pressure increase in the second pressure circuit, and the pressure increase of the first pressure circuit is essentially reduced by the amount of the pressure increase of the second pressure circuit, and the reduction in the pressure increase is less than a defined limit value.

### PRIOR ART

The invention relates to a pressure system having at least two pressure circuits that are each embodied with a respective positive-displacement element.

Pressure systems or brake pressure regulating systems known in the industry, such as ABS (anti-lock braking system), TCS (traction control system) or ESP (electronic stability program) systems are embodied with positive-displacement elements embodied as so-called single-piston pumps, which are driven by an electric motor via an eccentric. During the active pressure buildup on their compression side, the single-piston pumps pump across an eccentric angle that is smaller than 180°. In the remainder of the phase angle range of the eccentric, no pumping takes place on the part of the pump. The above-described pumping principle is characterized both by an undesirably great pressure increase during pumping or during the active pressure buildup phase and by a steep pressure gradient at the onset of the pressure buildup phase, which disadvantageously leads to unwanted noise production, especially during comfort-oriented functions of the aforementioned pressure systems. The pressure increase during the pressure buildup and pumping phase of the positive-displacement elements causes low-frequency noise, while steep pressure gradients at the onset of the pressure buildup phase excite the resonant frequencies of the entire pressure system and thus cause noise production over a wide frequency range.

The aforementioned pressure systems are embodied with at least two pressure circuits, and the single-piston pumps of the two pressure circuits do not pump simultaneously but instead pump with a phase offset of 180° from one another, and therefore the noise production or pumping noise of the pressure system occurs above all during comfort functions of an ESP unit, such as controlled braking in a driver assist system or a hydraulically operated automatic parking lock, in the operating mode of which the same system pressure is regulated in both pressure circuits of an ESP system.

It is therefore the object of the present invention to make a pressure system available that even in unfavorable operating states is characterized by little noise development.

According to the invention, this object is attained with a pressure system having the characteristics of claim 1.

### ADVANTAGES OF THE INVENTION

The pressure system of the invention, having at least two pressure circuits which are each embodied with a respective positive-displacement element, is characterized even during unfavorable operating states by low noise development, since the two pressure circuits, on a compression side of the positive-displacement elements, are in operative communication via a compensation device in such a way that a pressure increase in the first pressure circuit leads to a pressure increase in the second pressure circuit, and the pressure increase of the first pressure circuit is essentially reduced by the amount of the pressure increase of the second pressure circuit, and the reduction in the pressure increase is less than a defined limit value.

This means that pressure pulsations of the positive-displacement elements, which can be embodied for instance as single-piston pumps, when the system pressure in the two pressure circuits is the same or different can be distributed to both pressure circuits within a defined region, and the pressure gradient at the onset of a pressure buildup and pumping phase of a positive-displacement element is reduced in a simple way, compared to conventional pressure systems.

The embodiment according to the invention of a pressure system with at least two pressure circuits furthermore, with the same system pressure in the two pressure circuits, offers the capability of reducing the pulsation heights by half and therefore in the operation of the positive-displacement elements distributing them more uniformly via an eccentric over the entire operating angle range of 360°, thus advantageously smoothing the fundamental waviness of the pressure distribution in the pressure circuits, compared to pressure systems known in the industry. Moreover, the pressure gradients at the onset of a pressure buildup phase are reduced on the compression side of the positive-displacement elements, since a system elasticity of the pressure system is increased at the onset of the pressure buildup phase.

Further advantages and advantageous features of the subject of the invention can be learned from the description, drawings and claims.

### DRAWINGS

In the drawings, a plurality of exemplary embodiments of pressure systems embodied according to the invention are shown schematically and in simplified form and are described in further detail in the ensuing description; in the description of the various exemplary embodiments, for the sake of simplicity, the same reference numerals are used for components that are structurally and functionally identical. Shown are:

FIG. 1, a wiring diagram of a first exemplary embodiment of a pressure system of the invention;

FIG. 2, a wiring diagram of a second exemplary embodiment of a pressure system of the invention;

FIG. 3, a graphic comparison of two courses of an overelevation of pressure in a pressure circuit of a conventional pressure system and in a pressure circuit of a pressure system of the invention;

FIG. 4, a wiring diagram of a third embodiment of a pressure system of the invention;

FIG. 5, a region marked X in FIGS. 1 and 2 of a further embodiment of a pressure system of the invention, in which the positive-displacement elements are each embodied as dual-piston pumps;

FIG. 6, a graph comparing a plurality of courses of a pumping volume of the pressure circuits of the pressure system of FIG. 5, with and without a compensation device;

FIG. 7, the region X shown in FIGS. 1 and 2 of a further embodiment of the pressure system of the invention, in which the positive-displacement elements each include an single-piston pump and a compensation piston triggered with a 180° offset from the single-piston pump;

FIG. 8, the region X, shown in FIGS. 1 and 2, of a further exemplary embodiment of a pressure system of the invention, in which the positive-displacement element of the first pressure circuit is embodied as an single-piston pump, and the positive-displacement element of the second pressure circuit is embodied as a dual-piston pump; and

FIG. 9, a graph comparing two courses of an overelevation of pressure of a pressure circuit of the pressure system of FIG. 8, with and without a compensation device.

### DESCRIPTION OF THE EXEMPLARY EMBODIMENTS

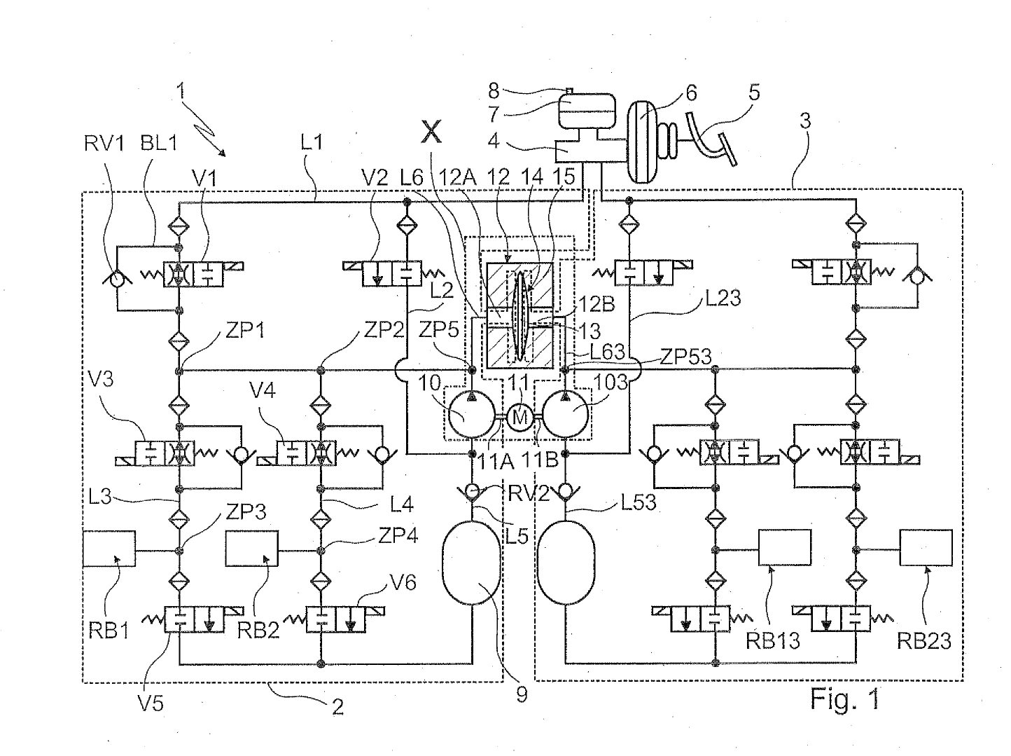

FIG. 1 shows a wiring diagram of a pressure system 1 or brake pressure regulating system of a vehicle, preferably a TCS or ESP system, which includes a first pressure circuit 2 and separate from it a second pressure circuit 3. The pressure circuits 2 and 3 are constructed identically, and therefore in the explanation of the functionalities of the components of the pressure circuits 2 and 3, only the first pressure circuit 2 will be described in detail in the ensuing description.

The two pressure circuits 2 and 3 in this case communicate with a master cylinder 4 and are subjected, from the master cylinder 4 as a function of an actuation by the driver of a brake pedal 5, to a hydraulic pressure boosted in a manner known per se via a brake booster 6. In the present case, the master cylinder 4 communicates with a hydraulic fluid container or brake fluid container 7, which in vehicles known in the industry is disposed in the engine compartment and can be filled via a filling neck 8; in the brake fluid container 8, essentially ambient pressure prevails.

A switchover valve V1 and a high-pressure switching valve V2 are disposed downstream of the master cylinder 4 in line segments L1 and L2 that are parallel to one another, so that the volumetric flow of hydraulic fluid originating at the master cylinder 4 in the first pressure circuit 2 can be carried selectively via the switchover valve V1 or the main pressure switching valve V2 in the direction of wheel brake cylinders RB1 and RB2.

In addition, downstream of the switchover valve V1 and the high-pressure switching valve V2, two line branching points ZP1 and ZP2, respectively, of the pressure circuit 2 are provided, which are each followed by a respective wheel inlet valve V3 and V4 embodied as switchover valves. The wheel inlet valves V3 and V4 and the switchover valve V1 are each embodied as a respective valve that is open when without current, so that the valves V1, V3 and V4, in normal operation of the pressure system 1 while the valves V1, V3 and V4 are not acted upon by their control currents, are open so that if the driver actuates the brake pedal 5, braking can be performed without delay.

The lead lines L3 and L4 for the wheel brake cylinders RB1 and RB2 branch off in the region of two further branching points ZP3 and ZP4 upstream of two wheel outlet valves V5 and V6, which are embodied as valves that are closed when without current, so that a pressure buildup in the wheel brake cylinders RB1 and RB2 requested by the driver is reliably assured in normal operation of the pressure system 1.

Upstream of the switchover valve V1, a bypass line BL1 embodied with a check valve RV1 branches off, so that in the event of a malfunction of the switchover valve V1 in which the hydraulic communication between the master cylinder 4 and the wheel brake cylinders RB1 and RB2 is interrupted by the switchover valve V1, continues to be available via the bypass line BL1 and a requested braking is executed even if the switchover valve V1 fails.

If it is ascertained via suitable devices that the vehicle wheel triggered by the wheel brake cylinder RB1 or the wheel brake cylinder RB2 is blocking in an unwanted way, the delivery of pressure to the wheel brake cylinder RB1 or the wheel brake cylinder RB2 in the region of the wheel inlet valve V3 or the wheel inlet valve V4 is blocked by a suitable supply of current to the electromagnetic actuating unit of the applicable valve, and the wheel outlet valve V5 or V6 corresponding to the respective wheel brake cylinder RB1 or RB2 is triggered in such a way that the pressure in the wheel brake cylinder RB1 or in the wheel brake cylinder RB2 is reduced by a required amount, and the blockage of the wheel is undone.

When the wheel outlet valves V5 and V6 are open, the hydraulic fluid carried via these two valves is delivered to a low-pressure reservoir 9, which in operation of the pressure system 1 preferably has an internal pressure of from 2 to 7 bar.

The possibility also exists of blocking the wheel inlet valves V3 and V4 when the wheel outlet valves V5 and V6 are closed, in order to avoid a further unwanted or impermissible pressure increase in the region of the wheel brake cylinders RB1 and RB2.

On the outlet side, the low-pressure reservoir 9 is in communication with an intake side of a positive-displacement element 10, which in this case is embodied as an single-piston pump, and in a connection line L5, between the low-pressure reservoir 9 and the positive-displacement element 10 that acts as a constant pump or pumping device with a constant positive-displacement volume, there is a check valve RV2, so that only hydraulic fluid from the low-pressure reservoir 9 can be carried in the direction of the positive-displacement element 10.

The line segment L2, which in the currentless state of the high-pressure switching valve V2 is blocked by this valve, discharges between the check valve RV2 and the positive-displacement element 10 into the connecting line L5 on the intake side of the positive-displacement element 10. Thus the volumetric flow of hydraulic fluid fed into the first pressure circuit from the master cylinder 4, given suitable current supply to the high-pressure switching valve V2 and a simultaneously closed switchover valve V1, can be delivered to the intake side of the positive-displacement element 10 between the check valve RV2 and the positive-displacement element 10, and the pressure in the region of the wheel brake cylinders RB1 and RB2 can be actively variable if needed by means of additional compression work, compared to the pressure originating at the brake booster.

This means that the two wheel brake cylinders RB1 and RB2, when the switchover valve V1 is closed and the high-pressure switching valve V2 is open, communicate with the compression side of the positive-displacement element 10 fluidically while the wheel inlet valves V3 and V4 are simultaneously open, and the hydraulic pressure originating at the master cylinder 4 is raised in the region of the positive-displacement element 10, in accordance with a rotational drive of an electric motor 11, in the required way to a pressure value which is needed for establishing various comfort-oriented functions of the pressure system 1. In addition, a compensation device 12 is subjected to the pumping pressure of the positive-displacement element 10, via a line L6 that branches off from a further branching point ZP5. In the present case, the compensation device 12 is embodied with a first conduit 12A with the line L6 of the first pressure circuit 2, and this first conduit is fluidically separated by a diaphragm 13 from a second conduit 12B communicating with the second pressure circuit 3.

The diaphragm 13 is thus subjected, on its side toward the first pressure circuit 2, to the hydraulic pressure of the line L6 and, on the side toward the second pressure circuit 3, to the pressure of a line L63 that communicates with the positive-displacement element 103 of the second pressure circuit 3.

Moreover, the diaphragm 13 is disposed in an at least approximately oval pressure chamber 14, and at its outer diameter it is connected solidly and in sealing fashion to a housing 15 of the compensation device 12. The diaphragm 13 is moreover made from an elastic plastic embodied to be resistant to both the hydraulic fluid and the pressure applied, so that as a function of a pressure drop between the two pressure circuits 2 and 3, the diaphragm 13 can be deformed within a predefined range in the pressure chamber 14, beginning at its central position shown in FIG. 1, in the direction of the conduit 12A or the conduit 12B. As a result of the deformation of the diaphragm 13, the volume of the first pressure circuit 2 varies, and this corresponds with the change in volume thus occurring simultaneously of the second pressure circuit 3. The dimensions of the pressure chamber 14 and of the conduits 12A and 12B are adapted to one another in such a way that the walls of the pressure chamber 14 are available as stops for the diaphragm 13, and thus the maximum deformation range of the diaphragm 13 inside the pressure chamber 14 is limited.

In the present instance, the displacement volume limited by the maximum deformability of the diaphragm 13, of the hydraulic fluid located on one side of a respective pressure circuit 2 or 3 in the compensation device 12 is dimensioned such that in each case it corresponds to half the pumping volume of the positive-displacement element 10 or 103. So that this displacement volume is displaceable even at small pressure differences, that is, only a few bar, between the pressure circuits 2 and 3, the diaphragm 13 should be embodied with a suitable elasticity. On the other hand, the geometry of the pressure chamber 14 is such that the diaphragm 13, when the maximum displacement volume is reached, presses against the wall of the pressure chamber 14, and no further hydraulic fluid is displaced inside the compensation device 12.

In the present instance, the diaphragm 13 is embodied with such a component elasticity and is installed in such a way in the housing 15 that, given the same pressure in the two pressure circuits 2 and 3, the diaphragm 13 automatically assumes the central position shown in FIG. 1.

In addition, the separation of the two pressure circuits 2 and 3 is still assured, as before, by the limited displacement volume in the region of the compensation device 12. Moreover, regulating actions at different system pressures in the two circuits are possible, so that the ABS, TCS and ESP functionalities of the pressure system 1 are unimpaired by the functionality of the compensation device 12.

It is understood that it is within the judgment of one skilled in the art to make the diaphragm 13 of the compensation device 12 from some other correspondingly suitable metal by means of which the above-described functionality of the compensation device 12 can be attained.

For instance, depending on the particular application in question, the possibility exists of making the diaphragm 13 either of plastic that is reinforced in at least some regions with metal or entirely of metal, so that the above-described functionality of the compensation device 12 can be reliably assured.

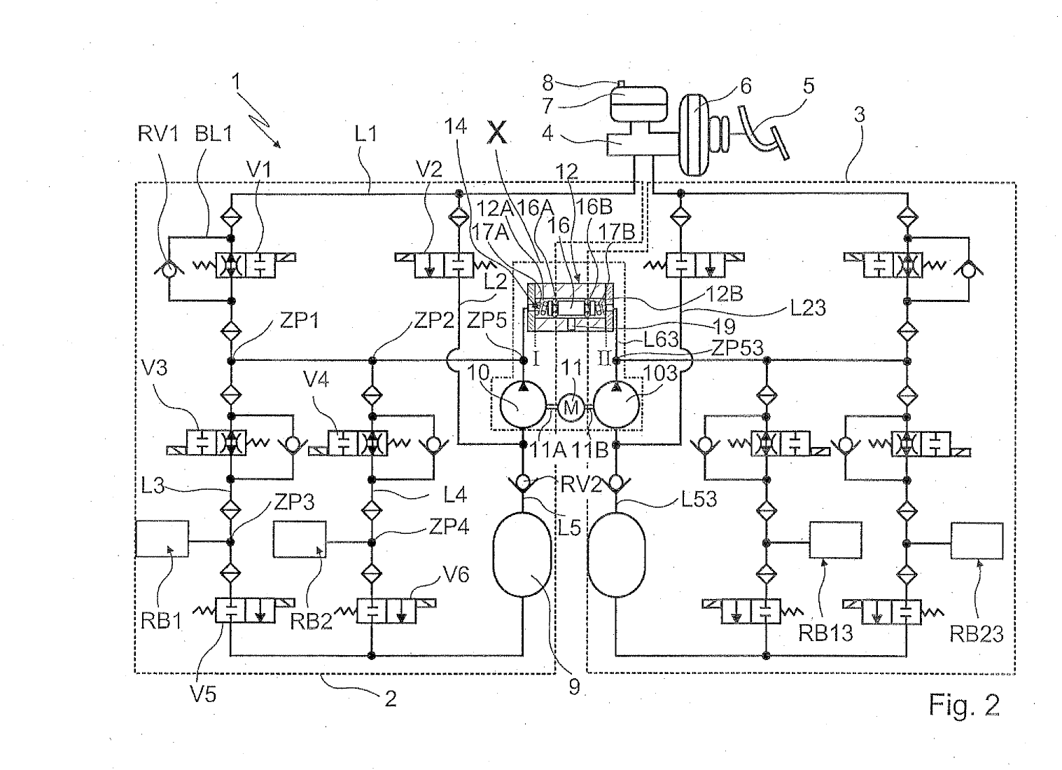

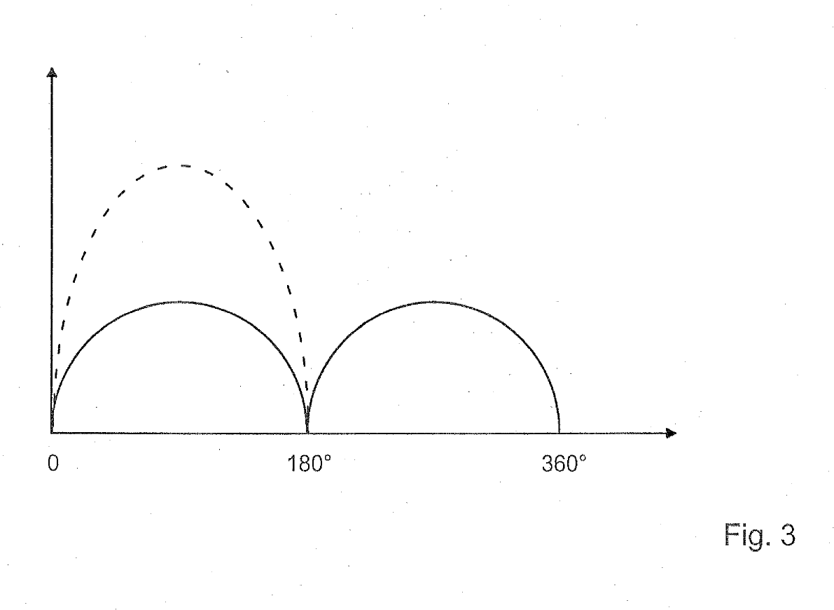

FIG. 2 shows the pressure system 1 of FIG. 1, with an embodiment that is structurally different from the compensation device 12 shown in FIG. 1 and by means of which the functionality described in further detail below in the description of FIG. 3 can be attained.

The compensation device 12 in FIG. 2 is embodied with a piston element 16, which is disposed longitudinally displaceably between two terminal positions I and II and is embodied in the region of its ends toward the conduits 12A and 12B with sealing elements 16A and 16B, so that the two pressure circuits 2 and 3 are separated from one another and the piston element 16 is displaceable between its terminal positions I and II without undoing the separation between the two pressure circuits 2 and 3. In addition, the piston element 16 is spring-damped between two spring elements 17A and 17B, so that given the same pressure in the two pressure circuits 2 and 3, the piston element 16 is positioned in the central position shown in FIG. 2.

Moreover, in a region which in all operating states of the pressure system 1 is located between the two sealing elements 16A and 16B, a leak fuel line 19, communicating with a low-pressure region not identified by reference numeral, branches off from the pressure chamber 14, so that a short circuit between the two pressure circuits 2 and 3, for instance if the sealing in the region of the piston element 16 is ineffective, is avoided.

In FIG. 3, a graph compares two qualitative courses of an overelevation of pressure in a pressure circuit of a conventional pressure system and in the pressure circuits 2 and 3 of the pressure system 1 of the invention, plotted over the working angle range of the eccentric drive of the positive-displacement elements 10 and 103; the course shown in dashed lines qualitatively represents the overelevation of pressure of a pressure system known in the industry, in the course shown in solid lines qualitatively represents the overelevation of pressure in the pressure circuits 2 and 3 of the pressure system 1 of the invention shown in FIG. 1 and FIG. 2.

In the present instance, the two positive-displacement elements 10 and 103 are driven by the electric motor 11 and by eccentrics, not identified by reference numeral in the drawing, that are disposed on the motor shafts 11A and 11B, so that the positive-displacement elements 10 and 103 embodied as single-piston pumps, during an active pressure buildup in the pressure circuits 2 and 3, pump hydraulic fluid over an eccentric angle that is smaller than 180°. In the remaining operating angle range, no pumping by a pump takes place, and therefore the course of an overelevation of pressure shown in dashed lines in FIG. 3 for a conventional pressure system ends at the angle value of 180°.

Since in the present instance the two positive-displacement elements of the two pressure circuits 2 and 3 pump with a 180° phase offset from one another, the use of the compensation device 12 shown in FIGS. 2 and 3 results in the course, shown by the solid line in FIG. 3, of the overelevation of pressure in the first pressure circuit 2 and in the second pressure circuit 3—given the same system pressure in the two pressure circuits—such that the pulsation of each positive-displacement element 10 and 103 is distributed uniformly to both pressure circuits 2 and 3, in the manner shown in FIG. 3, by the deformation of the diaphragm 13 and the displacement of the piston element 16.

Thus the pulsation heights in the pressure circuits 2 and 3 are each reduced by half and distributed in the manner shown over the entire angular range of 360°; as a result, the fundamental waviness of the pressure in the pressure circuits 2 and 3 is essentially smoothed out. Furthermore, the pressure gradients at the onset of the pressure buildup and pumping phase of the positive-displacement elements 10 and 103 are less than in a conventional pressure system, since the positive-displacement elements 10 and 103 are each operatively connected on their compression side with a system that at the onset of the pressure buildup and pumping phase is embodied with a considerably greater system elasticity than conventional pressure systems.

However, the possibility also exists, as a function of the particular application, of positioning the positive-displacement elements 10 and 103 on the circumference of the motor shafts 11A and 11B in such a way that the phase offset differs from the aforementioned angular value of 180° by a few degrees—preferably by from 5° to 10°—without impairing the mode of operation according to the invention of the compensation device 12.

By means of the above-described inventive embodiments of a pressure system, the pulsation of a positive-displacement element is converted by simple means, during only certain operating states of the pressure system, into the pulsation spectrum of a positive-displacement element that has twice as many positive-displacement elements, while the structurally simple principle of a positive-displacement element with the single number of positive-displacement elements is maintained. Thus the pulsation of an single-piston pump is for instance converted, by structurally simple means, into the pulsation spectrum of a dual-piston pump.

It is furthermore advantageous that by the use of a pressure system 1 of the invention, the pedal feel in the region of a motor vehicle brake system remains virtually constant, since the total elasticity of the hydraulic unit increases only slightly, and the separation of the pressure circuits of a brake system is completely unchanged.

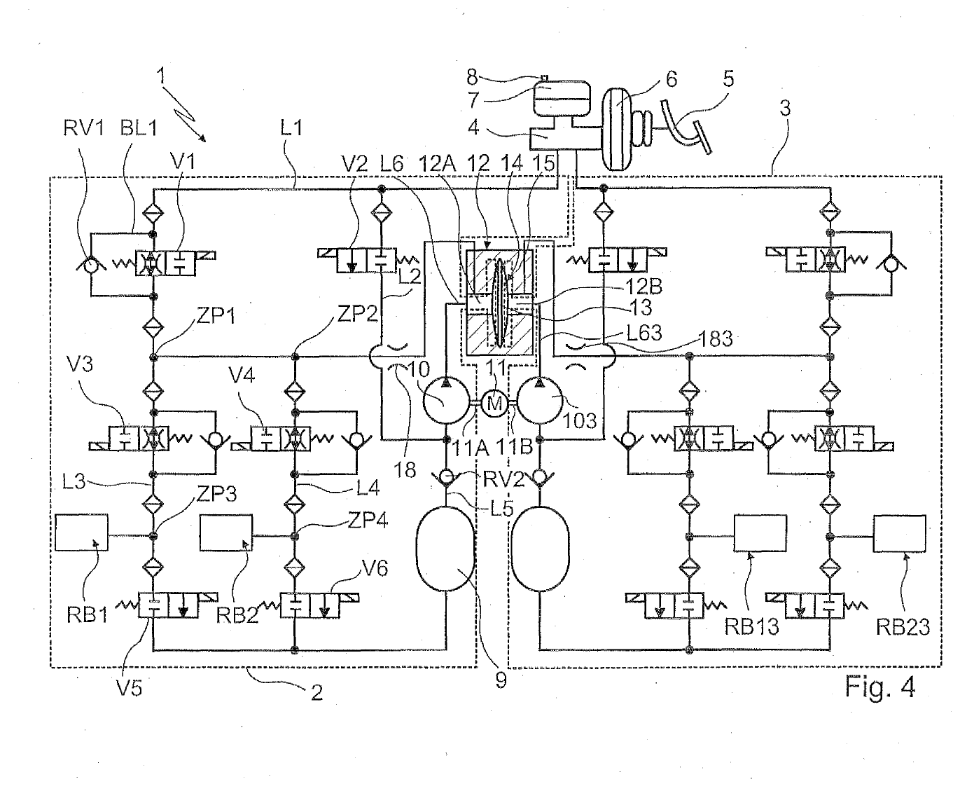

FIG. 4 shows a further exemplary embodiment of a pressure system 1 of the invention that differs only in the region between the positive-displacement elements 10 and 103, the compensation device 12, and the lead line region between the positive-displacement elements 10, 103 and the wheel brake cylinders RB1, RB2 of the first pressure circuit 2 and the wheel brake cylinders RB13 and RB23 of the second pressure circuit 3 that communicate, during active pressure buildup in the pressure system 1, with the positive-displacement elements 10 and 103.

In this embodiment of a pressure system of the invention, during an additional pressure buildup, the compressed hydraulic fluid is carried to the wheel brake cylinders RB1, RB2 and RB13, RB23, respectively, via the two positive-displacement elements 10 and 103 in the two pressure circuits 2 and 3 first via the compensation device 12 and then via respective throttle elements 18 and 183, disposed downstream of the compensation device 12, so that each of the pressure circuits 2 and 3 is embodied with a so-called hydraulic low-pass filter, by means of which the higher-frequency pressure fluctuations in the pressure circuits 2 and 3 are filtered.

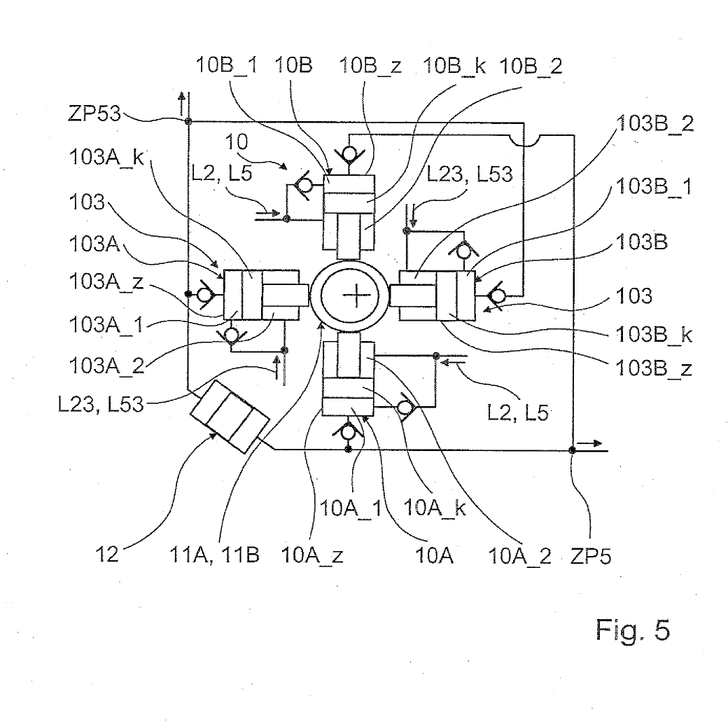

FIG. 5 shows the region X, identified in further detail by the dot-dashed line in FIGS. 1 and 2, which essentially includes the two positive-displacement elements 10 and 103 as well as the compensation device 12 of the pressure system 1 of the invention. In the embodiment of the pressure system 1 shown in FIG. 5, the two positive-displacement elements 10 and 103 are each embodied as dual-piston pumps, which in the present instance each include two piston-cylinder units 10A, 10B and 103A, 103B, respectively, offset from one another by 180°, all of which have essentially the same construction. It is understood that here as well, and in the exemplary embodiments of the pressure system 1 that are described later, the possibility exists of varying the phase offset between the components, disposed on the circumference of the motor shafts 11A, 11B, by a few degrees, depending on the particular application in that instance, without essentially affecting the mode of operation according to the invention of the compensation device 12.

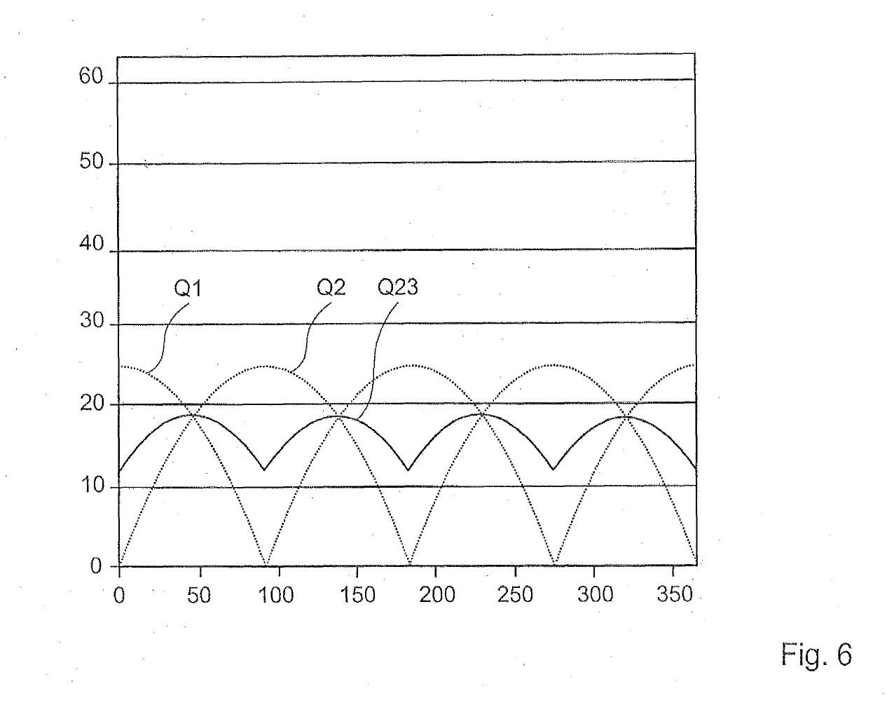

The piston-cylinder units 10A, 10B and 103A, 103B of the positive-displacement elements 10 and 103 each communicate on the intake side with the respective lines L2, L5 and L23, L53 and are operatively connected to one another in the manner described above on their pumping sides in the region of the compensation device 12, so that the effect, visible in the illustration in FIG. 6 and described in further detail in conjunction with the description of FIG. 6, is established in the operation of the pressure system 1.

The piston-cylinder units 10A through 103B are each embodied with stepped pistons 10A_k through 103B_k, which with cylinders 10A_z through 103B_z define piston chambers 10A_1, 10A_2 through 103B_1, 103B_2.

The piston-cylinder unit 10A of the positive-displacement element 10 will now be described in further detail during one complete revolution of the motor shafts 11A, 11B of the electric motor 11, in conjunction with the illustrations in FIGS. 5 and 6.

The piston-cylinder unit 10A will be looked at beginning at an operating state in which the piston 10A_k is at top dead center; the first piston chamber 10A_1 has its most minimal volume and corresponds to the end of the pumping phase of the piston-cylinder unit 10A. Next, because of the eccentricity of the motor shafts 11A, 11B, the piston 10A_k moves in the direction of its bottom dead center; the volume of the first piston chamber 10A_k becomes increasingly larger, while the volume of the second piston chamber 10A_2 decreases constantly in size. Since both the first piston chamber 10A_1 and the second piston chamber 10A_2 communicate with the lines L2 and L5 on the intake side of the positive-displacement element 10, and a communication between the piston chambers 10A_1, 10A_2 is also provided, the first piston chamber 10A_1 is filled during its intake phase via the lines L2 and L5 as well as from the second piston chamber 10A_2.

The upper piston chamber 10A_1 has its greatest volume at bottom dead center of the piston 10A_k and is essentially completely filled with hydraulic fluid. If the piston 10A_k is moved in the direction of its top dead center by the electric motor 11, the hydraulic fluid located in the upper piston chamber 10A_1 is compressed and is output to the pumping side of the positive-displacement element 10. At the same time, the volume of the second piston chamber 10A_2 increases because of the motion of the piston 10A_k, so that hydraulic fluid is aspirated into the second piston chamber 10A_2 from the lines L2 and L5.

FIG. 6 shows three supply quantity courses Q2, Q3 and Q23, which are plotted over the rotary angle of the motor shafts 11A, 11B. The courses Q2 and Q3 correspond to the volumes of a pressure system, which is embodied without the compensation device 12 of FIG. 1 or FIG. 2, that are pumped by the piston-cylinder units 10A and 10B, respectively, of the positive-displacement element 10 or by the piston-cylinder units 103A and 103B, respectively, of the positive-displacement element 103.

The course Q23 shown in FIG. 6 is established based on the disposition of the compensation device 12 between the two pressure circuits 2 and 3; the disposition of the compensation device 12 brings about a substantial smoothing out of the pumping curve of the positive-displacement elements 10 and 103.

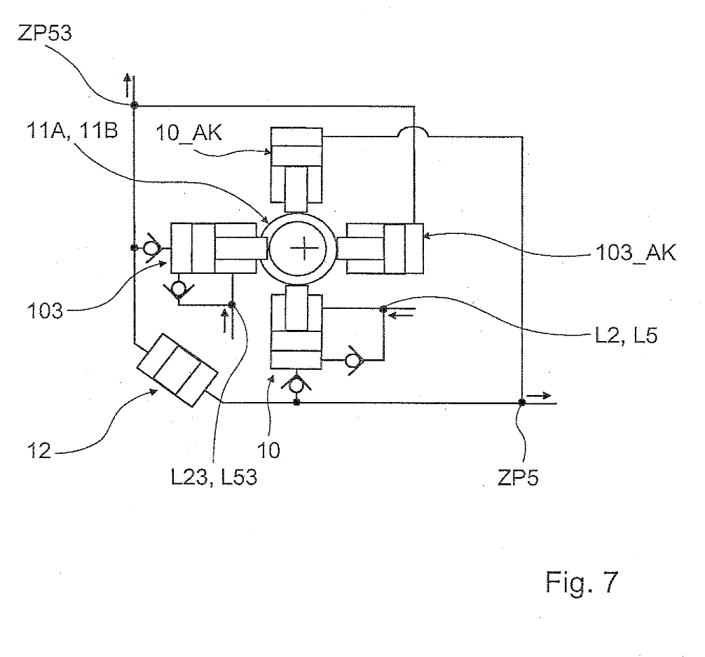

In FIG. 7, the region X, shown in detail in FIGS. 1 and 2, of a further embodiment according to the invention of the pressure system 1 of FIGS. 1 and 2, respectively, is shown. The embodiment shown in FIG. 7 differs from the above-described embodiments of the pressure system 1 in that the two positive-displacement elements 10 and 103 are each embodied as single-piston pumps, each with an associated compensation piston 10_AK and 103_AK. The positive-displacement elements 10 and 103 are each embodied with respective piston-cylinder units 10A and 103A, which essentially correspond to the piston-cylinder units of FIG. 5. The two compensation pistons 10_AK and 103_AK are provided instead of the further piston-cylinder units 10B and 103B of the pressure system 1 of FIG. 5 and are each positioned on the circumference of the motor shafts 11A, 11B and offset by 180° from the respective corresponding piston-cylinder unit 10A and 103A.

The compensation pistons 10_AK and 103_AK are each in communication with the pumping side of the respective piston-cylinder units 10A and 103A, so that the compensation pistons 10_AK and 103_AK, offset by 180° from the compensation pistons 10A and 103A, respectively, each pump during the intake phases of the piston-cylinder units 10A, 103 and have their own intake phase during the pumping phases of the piston-cylinder units 10A, 103A. This arrangement likewise leads to the above-described smoothing of the overelevation of pressure on the pumping sides of the positive-displacement elements 10 and 103. Moreover, the disposition of the compensation device 12 between the two pressure circuits 2 and 3 leads to a further smoothing of the pumping characteristic of the positive-displacement elements 10 and 103, so that the noise produced by the pressure system 1 in FIG. 7 is considerably improved, compared to pressure systems known per se.

The embodiment of FIG. 7, to the same extent as the embodiment of the pressure system of FIG. 5, has the fundamental advantage that because of the disposition of the compensation device 12 between the pressure circuits 2 and 3, zero pumping, or in other words a region in which no pumping per pressure circuit 2 and 3 occurs, is entirely eliminated, which leads to a considerable reduction in unwanted and uncomfortable operating noises of a pressure system.

In addition, the possibility exists of embodying the pressure system 1 of FIG. 7, downstream of each of the branching points ZP5 and ZP53, with further check valves in order to assure the function of the compensation pistons 10_AK and 103_AK in all the operating states of the pressure system 1.

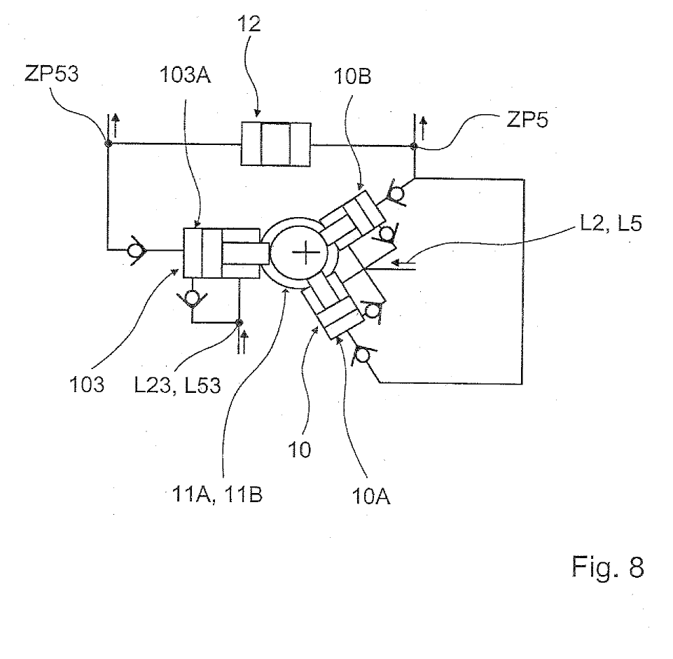

FIG. 8 shows the region X, shown in further detail in FIGS. 1 and 2, of a further exemplary embodiment of a pressure system 1, in which the positive-displacement element 10 of the first pressure circuit 2 is embodied as a dual-piston pump, with two piston-cylinder units 10A and 10B, each of which has half the stroke volume of the positive-displacement element 103, embodied as an single-piston pump, of the second pressure circuit 3.

The piston-cylinder units 10A, 10B and the piston-cylinder unit 103A of the positive-displacement element 103 of the second pressure circuit 3 have the same construction as the piston-cylinder units of the positive-displacement elements of FIG. 5, and reference is therefore made here to the description of FIG. 5.

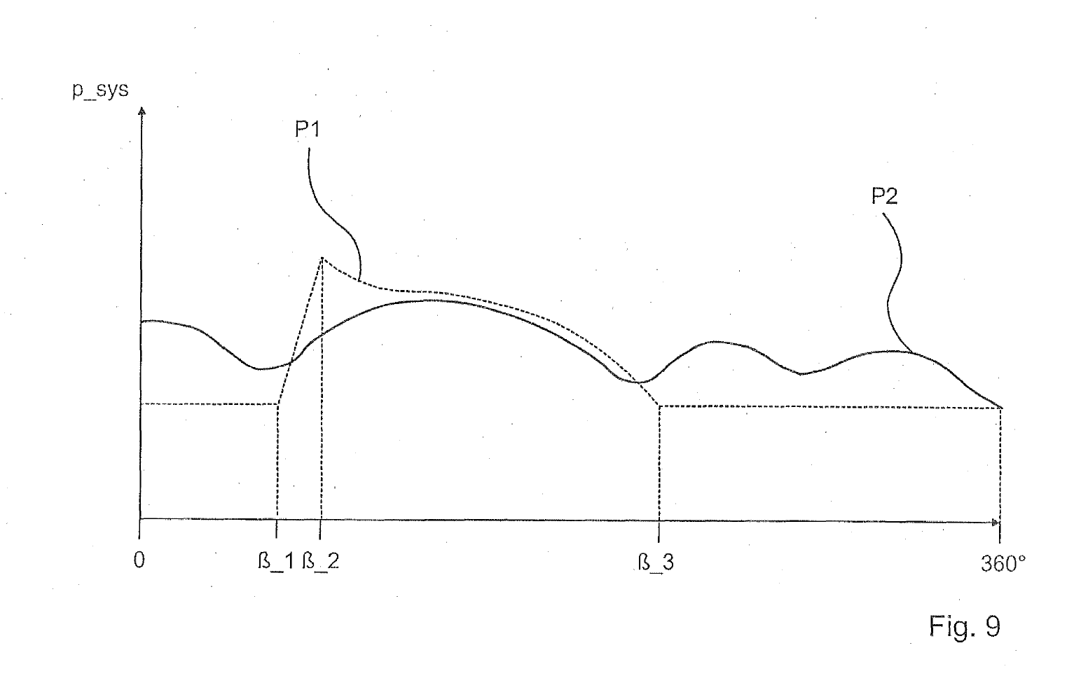

The disposition of the compensation device 12 between the two pressure circuits 2 and 3 leads to a change in the pumping characteristic of the positive-displacement elements 10 and 103, as can be seen from a comparison of the pressure courses P1 and P2 shown in FIG. 9.

The dashed line P1 represents the pumping characteristic of the first pressure circuit 2 of a pressure system during an operating cycle of 360°; the pressure system has the construction shown in FIG. 1 or 2 and is embodied with the positive-displacement elements shown in FIG. 8, but without the compensation device 12. It can be seen that the system pressure p_sys is constant up to a first rotary angle value β_1 and then with a steep gradient increases to a maximum that is attained at a second rotary angle value β_2 of the motor shafts 11A and 11B. Next, the system pressure p_sys decreases until a rotary angle value β_3 and, until the end of the operating cycle, remains at the constant low level prevailing before the first rotary angle value β_1 was reached.

The course P2 shown as a solid line corresponds to the pumping characteristic of a pressure system 1 of FIG. 1 combined with FIG. 8, which is embodied with the compensation device 12 disposed between the two pressure circuits 2 and 3. From the course P2, it can be seen that the disposition of the compensation device 12 brings about a smoothed pumping course over the entire operating range of the pressure system 1, that is, the range of revolution of the motor shafts 11A and 11B, and this leads to a reduction in the noise produced during operation of a pressure system.

1-13. (canceled)

14. A pressure system comprising first and second pressure circuits each including a respective positive-displacement element, and compression means providing operative communication between the compression sides of the positive-displacement elements in such a way that a pressure increase in the first pressure circuit leads to a pressure increase in the second pressure circuit, and the pressure increase of the first pressure circuit is essentially reduced by the amount of the pressure increase of the second pressure circuit, the reduction in the pressure increase being less than a defined limit value.

15. The pressure system as defined by claim 14, wherein the positive-displacement elements are single-piston pumps operatable with a 180° phase offset from one another.

16. The pressure system as defined by claim 14, wherein the positive-displacement elements are dual-piston pumps, whose piston-cylinder units are operatable phase-offset from one another, preferably by 180°.

17. The pressure system as defined by claim 14, wherein the positive-displacement elements are single-piston pumps, wherein the compensation means comprises a compensation piston assigned to each single-piston pump on the feed side, and wherein each single-piston pump and compensation piston of a respective positive-displacement element are operatable phase-offset from one another, preferably by 180°.

18. The pressure system as defined by claim 14, wherein the positive-displacement element of the first pressure circuit comprises a dual-piston pump and the positive-displacement element of the second pressure circuit comprises a single-piston pump, and wherein the pumping volume of the piston-cylinder units of the positive-displacement element of the first pressure circuit is equivalent to half the stroke volume of the piston-cylinder unit of the positive-displacement element of the second pressure circuit.

19. The pressure system as defined by claim 14, wherein the compensation device comprises an elastic diaphragm which is deformable between two limit deformation states and by which the two pressure circuits are separated on the compression sides of the positive-displacement elements.

20. The pressure system as defined by claim 17, wherein the compensation device comprises an elastic diaphragm which is deformable between two limit deformation states and by which the two pressure circuits are separated on the compression sides of the positive-displacement elements.

21. The pressure system as defined by claim 18, wherein the compensation device comprises an elastic diaphragm which is deformable between two limit deformation states and by which the two pressure circuits are separated on the compression sides of the positive-displacement elements.

22. The pressure system as defined by claim 19, further comprising a mechanical stop defining each state.

23. The pressure system as defined by claim 19, wherein the diaphragm is formed at least in some regions of metal.

24. The pressure system as defined by claim 22, wherein the diaphragm is formed at least in some regions of metal.

25. The pressure system as defined by claim 19, wherein the diaphragm is formed at least in some regions of plastic.

26. The pressure system as defined by claim 14, wherein the compensation device comprises a piston element which is displaceable between two terminal positions and can be acted upon on each end face by a pressure of a respective pressure circuit.

27. The pressure system as defined by claim 17, wherein the compensation device comprises a piston element which is displaceable between two terminal positions and can be acted upon on each end face by a pressure of a respective pressure circuit.

28. The pressure system as defined by claim 18, wherein the compensation device comprises a piston element which is displaceable between two terminal positions and can be acted upon on each end face by a pressure of a respective pressure circuit.

29. The pressure system as defined by claim 26, further comprising spring means damping the piston element on both sides.

30. The pressure system as defined by claim 14, wherein the volume of the first pressure circuit, whose pressure is increased by the pumping of the positive-displacement element, can be enlarged in the region of the compensation device by half the pumping volume of the positive-displacement element, while the volume of the second pressure circuit, in the region of the compensation device, is reduced by the volume by which the first pressure circuit is enlarged.

31. The pressure system as defined by claim 17, wherein the volume of the first pressure circuit, whose pressure is increased by the pumping of the positive-displacement element, can be enlarged in the region of the compensation device by half the pumping volume of the positive-displacement element, while the volume of the second pressure circuit, in the region of the compensation device, is reduced by the volume by which the first pressure circuit is enlarged.

32. The pressure system as defined by claim 18, wherein the volume of the first pressure circuit, whose pressure is increased by the pumping of the positive-displacement element, can be enlarged in the region of the compensation device by half the pumping volume of the positive-displacement element, while the volume of the second pressure circuit, in the region of the compensation device, is reduced by the volume by which the first pressure circuit is enlarged.

33. The pressure system as defined by claim 14, further comprising throttle means downstream of the compensation means.
